(19) United States
(12) Patent Application Publication
(10) Pub. No.: US 2005/0132907 A1
(43) Pub. Date: Jun. 23, 2005

(54) Method of printing a digital image onto a rigid board substrate

(75) Inventor: Dennis A. Elliott, Burbank, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Vignettes LLC, Las Vegas, NV (US)

(21) Appl. No.: 10/999,321

(22) Filed: Nov. 30, 2004

(51) Int. Cl. B41F 15/00; G06K 15/02; B41F 15/26; B41L 13/00; B41F 15/36; B41F 17/00

(52) U.S. Cl. 101/35; 358/1.12; 101/44; 101/126; 101/114; 101/127.1

(57) ABSTRACT

A method of printing an image onto a rigid board is disclosed. The method comprises providing a printer and providing a template having a first surface and a second, opposite surface. The template is registered relative to the printer and an image is printed onto the template first surface. A portion containing the image is removed from the template, forming an aperture of substantially the same dimension as the rigid board. The rigid board is placed into the recess, and the template is re-registered relative to the printer. The image is then printed onto the rigid board.

### CROSS-REFERENCE TO RELATED APPLICATIONS

None.

### Federally Sponsored Research or Development

Not Applicable.

### TECHNICAL FIELD

This invention generally relates to printing of a digital image onto a particular substrate and, more particularly, to the printing of a digital image onto a hardboard substrate.

### BACKGROUND OF THE INVENTION

A rigid board substrate, such as a clay-coated hardboard substrate commonly known as clayboard, is often utilized in the fine art print industry, in part based upon the archival qualities of the substrate. For example, current systems use clayboard for serigraph printing, a type of stencil printing process wherein an image is superimposed and/or ink is forced through a fine screen onto the clayboard. This is often marketed to consumers as “fine art limited edition serigraph print on board.”

Technological advances in digital printing have enabled high quality services in the fine art industry, such as print-on-demand for limited edition prints. However, it has been difficult to properly register the clayboard relative to the printer so that the image is correctly located on the clayboard.

The present invention is provided to address these and other issues.

### SUMMARY OF THE INVENTION

It is an object of the invention to provide a method of printing an image onto a rigid board. The method comprises providing a printer, providing a template having a first surface and a second, opposite surface, and registering the template relative to the printer. The method further comprises printing the image onto the template first surface, removing from the template the portion containing the image, forming an aperture of substantially the same dimension as the rigid board. The rigid board is placed into the recess, the template is re-registered relative to the printer, and the image is printed onto the rigid board.

It is contemplated that the rigid board is clayboard.

It is further contemplated that template is foam core.

It is still further contemplated that the rigid board is supported in the aperture, such as by a poster board attached to the second surface of the template.

It is yet further contemplated that the poster board has an inner surface attached to the second surface of the template and an opposite, outer surface, and the outer surface is roughened, such as by using 100 grit sandpaper.

It is further contemplated that the printer has a printer bed supporting the template, and the printer registration marking are located on tape attached to the printer bed.

It is still further contemplated that the template includes a template registration marking for registering the template relative to the printer.

It is yet further contemplated that the printer has guide wheels, and the template registration marking is registered relative to the guide wheels.

It is yet further contemplated that a spacer tool is included for registering the template registration marking relative to the guide wheels.

It is still further contemplated that the printer includes a printer registration marking for registering the template relative to the printer.

It is also contemplated that the printer has a take-up reel, and the take-up reel is coupled to the template to provide a forward bias on the template as the template travels through the printer.

### BRIEF DESCRIPTION OF THE DRAWINGS

FIG. 1 is an illustration of a system for performing the present invention;

FIG. 2 is a sectional view of a template in accordance with the present invention;

FIG. 3 illustrates one step in accordance with the present invention;

FIG. 4 illustrates another step in accordance with the present invention; and

FIG. 5 illustrates a mechanism for biasing a template through a printer in accordance with the present invention.

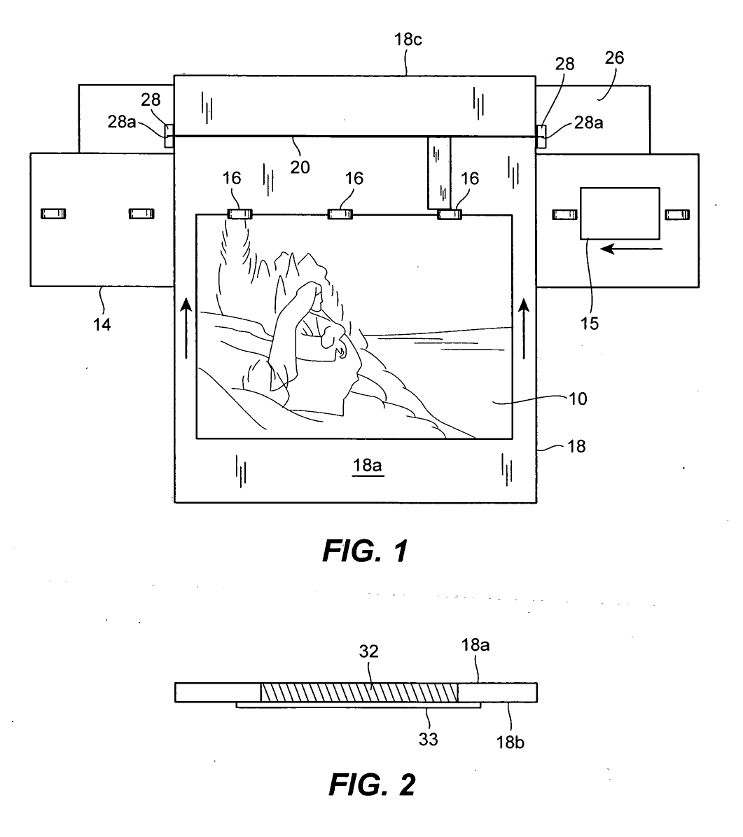

### DETAILED DESCRIPTION OF PREFERRED EMBODIMENTS

While this invention is susceptible of embodiment in many different forms, there is shown in the drawing, and will be described herein in detail, specific embodiments thereof with the understanding that the present disclosure is to be considered as an exemplification of the principles of the invention and is not intended to limit the invention to the specific embodiments illustrated.

A method of printing an image 10 onto a rigid board 12 is illustrated in the Figures. The rigid board 12 is preferably one-eighth inch thick clay-coated hardboard, commonly referred to as clayboard, such as provided by Ampersand Art Supply, of Austin Tex. See www.ampersandart.com. The image 10 to be printed onto the rigid board 12 is typically of the same dimension as that of the rigid board 12 itself. In other words, the image 10 is printed substantially to the edges of the rigid board 12.

A printer 14 is provided. The printer 14 may be a JV-4 series digital printer, sold by Mimaki U.S.A. See www.mimakiusa.com. The printer 14 has printing heads 15 which are height adjustable to accommodate media of differing thicknesses. The printer 14 also has a lower drive mechanism (not shown) and a plurality of free-wheeling upper guide rollers 16 which cooperatively drive the medium onto which the image 10 is to be printed through the printer 14. The printer 14 is conventionally coupled to a personal computer (not shown). An electronic file of the image 10 is stored in a conventional manner on the personal computer before it is transmitted to the printer 14.

A template 18 is provided having a first surface 18a, a second surface 18b, and a leading edge 18c. The template 18 is preferably one-eighth inch foam core, the same thickness as that of the clayboard. A template registration marking 20 is provided on the template 18 a distance from the leading edge 18c of the template. In the present embodiment, the distance is four inches. The template 18 is registered relative to the guide rollers 16 utilizing a spacer tool 24.

The printer 14 includes a printer bed 26. A piece of conventional tape 28, such as duct tape, is adhered to the printer bed 26 adjacent the template registration marking 20 on each lateral side of the template 18, and a printer registration marking 28a is made on each of the pieces of tape, aligned with the template registration marking 20. The template 18 is again checked for alignment with the guide rollers 16, and then the image is printed onto the template first surface 18a. The lower drive mechanism moves the template 18 through the printer 14. To insure the template 18 moves smoothly, an operator can manually provide a slight forward pressure on the template 18, biasing the template 18 in the forward direction.

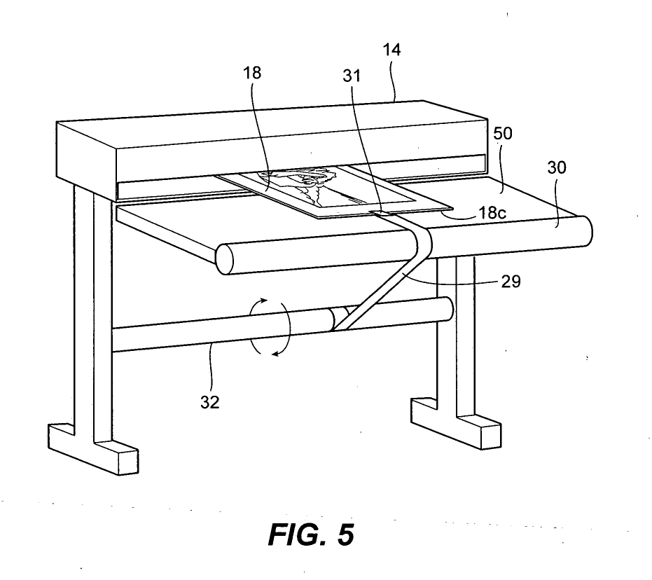

Alternatively, a strip of canvas 29 extending over a tube 30 can connect the template 18 with a clip 31 to a conventional take-up reel 32 on the printer 14, to provide the forward bias. (See FIG. 5).

As long as the template 18 is properly registered relative to the printer 14, the image will always print at the same precise location on the template 18. The template 18 is registered relative to the printer 14 so that the image will print generally in the center of the template.

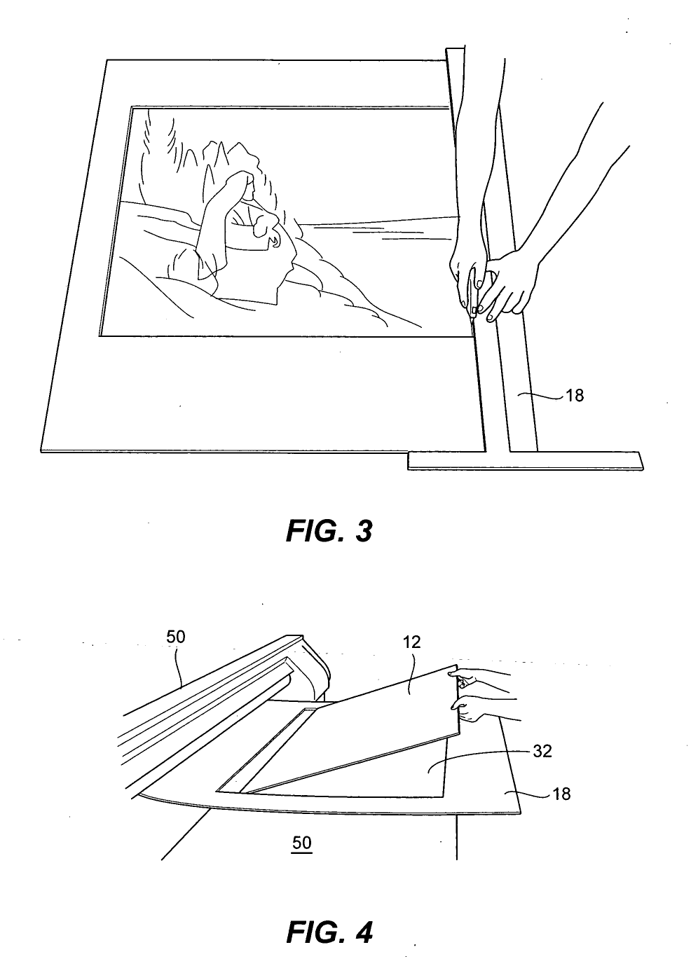

The portion of the template 18 containing the image is then carefully removed, such as with straight-edge and a razor blade, forming an aperture 32 of the same dimension as the rigid board 12. See FIG. 3. One side of a supporting surface 33, such as one-sixteenth inch poster board, is roughened up, using 100 grit sand paper. The supporting surface 33 is attached to the template second surface 18b, such as by double-sided tape, with the roughened surface facing outwardly.

The rigid board 12 is placed into the aperture 32, where it is supported by the supporting surface 33. See FIG. 4. Because the image to be printed onto the rigid board 12 is of the same dimension as that of the rigid board 12 itself, and thus the same dimension as the portion removed from the template 18, the rigid board 12 will fit snugly in the aperture 32.

The template 18 is then re-registered with the printer 14, utilizing the template registration marking 20, the printer registration markings 28a and the guide rollers 16. Once re-registered, the image is printed onto the rigid board 12, which is located exactly where the previous printing occurred. Once printed onto the rigid board 12, the rigid board 12 is removed, and is conventionally varnished using two sprayed on coats of water base matte varnish, and set aside to dry for five hours. Another rigid board 12 can now be placed in the template, the template 18 re-registered with the printer 14, and another image made.

The roughened surface of the poster board help the lower drive mechanism to better engage the template during printing.

Stands 50 are set on each side of the printer 14 to create stability and ease of movement for the template 18 entering and exiting the printer 14. The stands 50 are set to the same height as the entrance and exit of the printer 14.

From the foregoing, it will be observed that numerous variations and modifications may be effected without departing from the spirit and scope of the invention. It is to be understood that no limitations with respect to the specific apparatus illustrated herein is intended or should be inferred. It is, of course, intended to cover by the appended claims all such modifications as fall within the scope of the claims.

1. A method of printing an image onto a rigid board comprising:
providing a printer;
providing a template having a first surface and a second, opposite surface;
registering the template relative to the printer;
printing the image onto the template first surface;
removing from the template the portion containing the image, forming an aperture of substantially the same dimension as the rigid board;
placing the rigid board into the recess;
re-registering the template relative to the printer; and
printing the image onto the rigid board.

2. The method of claim 1, wherein the rigid board is clayboard.

3. The method of claim 1, wherein the template is foam core.

4. The method of claim 1 including supporting the rigid board in the aperture.

5. The method of claim 4, wherein the support is attached to the second surface of the template.

6. The method of claim 5, wherein the support is poster board.

7. The method of claim 6, wherein the poster board has an inner surface attached to the second surface of the template and an opposite, outer surface, and including roughing the outer surface of the poster board.

8. The method of claim 7, wherein the outer surface is roughened using 100 grit sandpaper.

9. The method of claim 8, wherein the printer has a printer bed supporting the template, and the printer registration marking are located on tape attached to the printer bed.

10. The method of claim 1, wherein the template includes a template registration marking for registering the template relative to the printer.

11. The method of claim 1, wherein the printer has guide wheels and the template registration marking is registered relative to the guide wheels.

12. The method of claim 11 including a spacer tool for registering the template registration marking relative to the guide wheels.

13. The method of claim 10, wherein the printer includes a printer registration marking for registering the template relative to the printer.

14. The method of claim 1, wherein the printer has a take-up reel, and including coupling the take-up reel to the template to provide a forward bias on the template as the template travels through the printer.

15. A method of printing an image onto a rigid board comprising:
providing a printer;
providing a template having a first surface and a second surface;
providing a template registration marking on the template;
providing a printer registration marking on the printer
aligning the template registration marking relative to the printer registration marking;
printing the image onto the template first surface;
removing from the template the portion containing the image, forming an aperture of substantially the same dimension as the rigid board;
placing the rigid board into the recess;
re-aligning the template registration marking relative to the printer registration marking; and
printing the image onto the rigid board.

16. The method of claim 15, wherein the rigid board is clayboard.

17. The method of claim 15, wherein the template is foam core.

18. The method of claim 15 including supporting the rigid board in the aperture.

19. The method of claim 18, wherein the support is attached to the lower surface of the template.

20. The method of claim 19, wherein the support is poster board.

21. The method of claim 20, wherein the poster board has an inner surface attached to the lower surface of the template and an opposite, outer surface, and including roughing the outer surface of the poster board.

22. The method of claim 21, wherein the outer surface is roughed using 100 grit sandpaper.

23. The method of claim 22, wherein the printer has a printer bed supporting the template, and the printer registration marking are located on tape attached to the printer bed.

24. The method of claim 15, wherein the printer has a take-up reel, and including coupling the take-up reel to the template to provide a forward bias on the template as the template travels through the printer.

25. A method of printing an image onto a rigid board comprising:
providing a printer having a plurality of guide rollers;
providing a template having a first surface, a second surface and a leading edge;
providing a template registration marking on the template disposed a distance from the leading edge of the template;
registering the template relative to the guide rollers;
locating a printer registration marking on the printer adjacent the template registration marking of the registered template;
printing the image onto the template first surface;
removing from the template the portion containing the image, forming an aperture of substantially the same dimension as the rigid board;
placing the rigid board into the recess;
re-aligning the template registration marking relative to the printer registration marking; and
printing the image onto the rigid board.

26. The method of claim 25, wherein the rigid board is clayboard.

27. The method of claim 25, wherein the template is foam core.

28. The method of claim 25 including supporting the rigid board in the aperture.

29. The method of claim 28, wherein the support is attached to the lower surface of the template.

30. The method of claim 29, wherein the support is poster board.

31. The method of claim 30, wherein the poster board has an inner surface attached to the lower surface of the template and an opposite, outer surface, and including roughing the outer surface of the poster board.

32. The method of claim 31, wherein the outer surface is roughed using 100 grit sandpaper.

33. The method of claim 32, wherein the printer has a printer bed supporting the template, and the printer registration marking are located on tape attached to the printer bed.

34. The method of claim 25 including re-aligning the template registration marking relative to the guide wheels prior to printing the image on the rigid board.

36. The method of claim 25, wherein the printer has a take-up reel, and including coupling the take-up reel to the template to provide a forward bias on the template as the template travels through the printer.

37. A template for carrying a rigid board through a printer for printing an image onto the rigid board, the template comprising:
an aperture of substantially the same dimension as the rigid board adapted to receive the rigid board; and
a registration marking on the template adapted to register with a registration marking on the printer.
